(19) United States
(12) Patent Application Publication
(10) Pub. No.: US 2007/0098378 A1
(43) Pub. Date: May 3, 2007

(54) Device for taking photographs

(76) Inventor: Lionel Giacomuzzi, (US)

Correspondence Address: OMORI & YAGUCHI USA, LLC, EIGHT PENN CENTER, SUITE 1901, 1628 JOHN F. KENNEDY BOULEVARD, PHILADELPHIA, PA, 19103, US

(21) Appl. No.: 10/560,388

(22) PCT Filed: Jun. 11, 2004
(86) PCT No.: PCT/FR04/01459

§ 371 Date: Dec. 13, 2005

(30) Foreign Application Priority Data
Jun. 13, 2003 (DE) 03/07171

(51) Int. Cl. G03B 15/00

(52) U.S. Cl. 396/1

(57) ABSTRACT

The invention relates to a device for taking photographs (1), characterized in comprising a combination of a) an articulated arm (2), with a first end (2-1), for fixing to a stable support (3) and a second free end (2-2), said second end (2-2) being extendable into a photograph-taking position and retractable into a position for waiting to take photographs, b) a device for taking photographs (4), fixed to said articulated arm means (2) at said second end (2-2) of said articulated arm and c) a mounting means (10), for mounting said device for taking photographs (4) on said articulated arm means (2).

### FIELD OF THE INVENTION

The present invention generally relates to the field of photograph taking devices.

More particularly, the present invention relates to a device for taking photographs, to be used for taking a photograph with quick delivery of the photograph, for example in a hairdressing salon or in a grooming salon for animals (dogs, . . . ).

### BACKGROUND OF THE INVENTION

Photograph-taking devices comprising a still camera mounted on an articulated arm are known.

US 2002/0171757 A1 (application Ser. No. 10/144,931) (document D1) describes an adjustable system for image taking, including a photograph taking apparatus (100) mounted on an articulated arm (102). This system is an image-taking system for an office, able to photograph a document (108) with possibilities of setting a position of the photograph-taking apparatus.

FR 2668872 A1 (application number 90-13836) (document D2) describes an adjustable apparatus for image taking. This system is an image-taking system for meteorology, able to photograph an object (7) mounted on a plate (2) with possibilities of setting a position of the photograph-taking apparatus.

Those documents D1 and D2 are representative of prior art and are devices for taking images of an object, while permitting an accurate adjustment or setting for the spatial position of the image-taking apparatus, then blocking the position of the image-taking apparatus on said adjusted position.

Those prior art devices are not specifically adapted for constituting a functional assembly, i.e. a group of means offering, as a whole, all functions useful for taking portraits of persons, i.e. all functions usually provided in a “photographic studio” at a professional photographer's, which usual functions are:

providing, in an spatially adjustable manner, a camera and blocking the camera in such an adjusted position; and also

providing, in an spatially adjustable manner, a background screen; and also

providing, in an adjustable manner, lightings; and also

transmission of the picture digital information, directly, to a printer and/or picture/image storage means.

To date, people wishing to get in a quick manner a photograph of themselves, of one of their relatives (children, etc.) or of a domestic animal, have two solutions: either to go to a photographer's who will take the photograph, either to go to a predetermined place (shopping mall, etc.) where there is an automatic quick photograph taking apparatus.

In both cases, the person is obliged to go to a specific place and to have a special care to her appearance (hair-style, clothing, etc.) or to the one of the photograph subject (child or animal). This double operation constitutes a specific step.

In the case of a photograph taking in a photographer's, it is necessary to make an appointment in advance and/or to be sure that the photographer will be present. Besides, one can note that photoshops do not always deliver the taken photograph in a quasi-immediate manner. So, the person must very often go back to the photoshop to recover her photograph. The global step is therefore boring and time consuming. Moreover, it is more and more uncommon to find photoshops that take photographs (global profitability problem).

In the case of a quick photograph taking apparatus, it may happen that the photograph taking apparatus has broken down, which necessitates the person consuming time to find another one and to go to it. Moreover, the thus taken photographs are not always of a good quality and the person gets no aesthetic advice from a professional.

Therefore, there is a need for a photograph taking device for a quick delivery of quality photographs without the need of a boring specific step from the person wishing to get such a photograph.

### SUMMARY AND ADVANTAGES OF THE INVENTION

The above-mentioned need is satisfied by providing a photograph taking device preferentially located in business premises, for example a hairdressing salon.

According to an essential characteristic of the invention, there is provided a photograph taking device comprising in combination: a) an articulated arm means comprising a first end to be fixed to a stable support and a second free end, said second end being extensible in a photograph taking position and retractable in a photograph taking waiting position; b) a photograph taking apparatus fixed to said articulated arm means at said second end of said articulated arm; c) a mounting means for mounting said photograph taking apparatus on said articulated arm means; and d) a screen forming a background for the subject to be photographed.

According to an alternative, said first end can be fixed to a stable vertical partition like a wall.

According to another alternative, the device further includes, in an integrated manner, a screen constituting a background for the subject to be photographed.

According to another alternative, said mounting means comprises a support stage comprising, mounted on it, said photograph taking apparatus and a free rotatable linkage permanently fixed in a rigid manner and vertically on said articulated arm means.

According to yet another alternative, said support stage further comprises a fixing means for fixing said photograph taking apparatus on said support stage.

Therefore, the person wishing a photograph is no more obliged to carry out a specific step. She can take advantage of her generally periodic visits to the hairdresser's for the photograph taking. Taking the photograph after the photograph subject has been hair dressed offers as an advantage that the subject's appearance is straightaway adapted to the photograph taking, without the need of an effort specific to the circumstance. According to a more detailed manner, a make-up alteration before taking a photograph can be certainly effected in the hairdressing salon, should this happen by taking advantage of the hairdresser's advice, since the hairdresser is a professional certainly having an optimum qualification concerning aesthetic harmony. The whole operation “preparation of the photograph subject and photograph taking” is therefore concentrated in a unique place and in a short time, which is very advantageous. The fact that the professional taking the photograph is no longer a “professional photographer” (who basically has a maximum qualification for the photograph taking technique and a more secondary qualification for the aesthetic aspect) but a “professional of the aesthetic field as a hairdresser” (who basically has a maximum qualification for the aesthetic aspect and a more secondary qualification for the photograph taking technique) is not presently a disadvantage because the recent technical evolution of the photograph taking apparatus, particularly the digital ones, and of the printing machines has as a consequence the fact that the current performances make the photograph taking technique much easier for a not very technically qualified person.

According to a more specific manner, said articulated arm to which the photograph taking apparatus is fixed is an articulated arm of the type commonly called “acrobat” as found in a hairdresser salon, said articulated arm, in its native function, supporting a hairdressing helmet.

In its photograph taking waiting position, the articulated arm is folded and raised up to a height of about 2.50 meters (high position) so that it does not impede the normal operation of the hairdressing/grooming salon and it is kept out of the reach of children. In its photograph taking position, the articulated arm is extended and moved away from the wall. Particularly, it can be lowered to about 1.50 m (low position) for the photograph taking. Its maneuverability range permits it to be oriented as desired on the left/right, downwardly/upwardly and in a circularly manner. It can thus be adapted to all configurations of a hairdressing/grooming salon.

When taking a photograph, the photograph subject makes himself comfortable, either standing up, either sitting down on a seat set to this purpose in the salon. A movable partition is then eventually pulled for isolating the subject from the rest of the salon. The articulated arm is pulled to be moved away from the wall and lowered and the photograph taking is done. Immediately after, the partition is returned to its initial position, the articulated arm is folded against the wall and raised up. The whole photograph taking operation is very quick and does not impede the general operation of the salon.

According to a more particular manner, for doing the operation comprising the extension of the articulated arm and its folding against the wall, one can reuse in a clever manner the native function of the articulated arm for the hairdressing helmet. In a native manner, such an articulated arm is provided with a springs system that causes an exact balance of the weight of the helmet so that it always stays in the position in which it is put by an operator. In the case of the photograph taking device, one keeps the same springs system; but since the photograph taking apparatus replacing the helmet is lighter than the helmet, when the articulated arm is folded against the wall, the arm always goes back up in its high position (about 2.50 m). Besides, when taking a photograph, the operator catches in his hand the photograph taking apparatus—that otherwise aims to go back up in its high position because of the spring return effect of the springs system—and realises its photograph taking in an automatic horizontality mode of the centring. This mode is auto-provided by the support stage that is by construction always maintained horizontally because the free rotatable linkage along the vertical axis 15 which is linked to the articulated arm as above-mentioned but which is also linked to said support stage always stays vertical (vertical axis 15), whatever the position of the articulated arm is. This particularity of vertical orientation maintenance of the vertical axis 15 of the free end of the articulated arm, whatever the position in space of the free end of the articulated arm, results from the global specific mechanical construction of the articulated arm, as is well known of the art.

Because of the spring return effect and of the automatic horizontality effect of the centring, the photograph taking operations are highly simplified for the operator, who has no need to have special qualifications in photography. This characteristic of the automatic mechanical maintenance of the horizontality of the aiming axis of the photographic apparatus while the person handling the photographic apparatus can freely move it in the three dimensions of space (of course, within the displacement limits of the articulated arm) in the aim to realise the correct centring of the subject to be photographed is a very advantageous characteristic for facilitating the correct photograph taking without the person handling the photographic apparatus being a “professional photographer”. This person can be, on the contrary, an “amateur” person without specific qualifications in the field of photograph taking. The very high sensitivity of the current digital photographic apparatus induces as a consequence that the normal general lighting of a room as a hairdressing salon is always sufficiently intensive so that there is no more need for any specific lighting setting up for lighting the subject to be photographed, which facilitates even more the photograph taking by this non skilled person.

The photograph taking apparatus is a digital apparatus that is preferentially connected by an infrared port (wireless link) to a digital printing machine for a direct printing of the photographs. The delivery of the photographs is thus quasi-instantaneous, which is advantageous.

In the case where the photograph taking apparatus is a classical apparatus supplied by a rechargeable battery or by a cell, there is no need of an electrical setting up for its operation. However, because of the eventually important quantity of photographs taken in a given period (the day, the week, . . . ), it can be advantageous to have an electrically supplied photographic apparatus to avoid recharging the battery or to replace the cell too often. In this case, it is advantageous to use in a judicious manner the native construction of the articulated arm: as described in a detailed manner hereunder, one can locate the mains alternative voltage—low voltage direct current transformer necessary for the electrical supply of the photographic apparatus inside the base for the mounting of the non free part of the articulated arm on the above-mentioned wall partition. By so doing, electrical security standards are satisfied. The conduction of the electric current from the transformer to the photographic apparatus is done through an electric wire running inside the articulated arm, as provided in a native manner. One can thus note that, on one hand, the operating security is satisfied and on the other hand, there is no need to provide any specific arrangement for supplying the photographic apparatus since the articulated arm natively incorporates the arrangements (base and sheath for electrical wire passing through) permitting it. Costs are reduced and the carrying out is facilitated.

Advantageously, the digital printing machine can have several layouts: portrait, identification photographs by two or others. The digital printing machine can furthermore have an automatic cutting function, that permits delivering “dimensioned” photographs to the customer.

The printing machine can be located at the salon cash desk. Therefore, while paying her hairdressing/grooming and photography bill, the person recovers her photographs while she is at it, which is quick, simple and convenient.

The printing machine can be located under a protection/shielding carter kept under pressure to provide a shielding of the printing machine against dust particulates, hair and/or hairs and other particulate matters as found in a hairdressing/grooming salon.

Advantageously, the printing machine can be joined with a mass storage device for filing the taken photographs. Therefore, the customer will have the possibility to get photographs in an immediate manner and/or the possibility to come and ask for new prints. Moreover, the freshly done hairdressing and/or grooming being so saved, the customer will have the opportunity to look at them on his next visit in the salon for having a precise viewing of an appearance state he wishes to realise again or on the base of which he wishes to make alterations. Of course, the services provider (the “boss” of the salon) can contemplate asking for a payment for such a specific service.

Other objects, characteristics and advantages of this invention will become understood from the following detailed description with reference to the accompanying drawings.

### BRIEF DESCRIPTION OF THE DRAWINGS

In the accompanying drawings:

FIG. 1 shows a general outline of the photograph taking device set up in a context “ready to use”, the photograph taking waiting position and the photograph taking position being both shown;

FIG. 2 is a detailed perspective view of the photograph taking device in its photograph taking waiting position, the view showing its different constitutive elements;

FIG. 3 is a schematic perspective view of the photograph taking device specifically showing the types of the cinematic linkages of the articulated arm;

FIG. 4 is a more detailed cross-section view of an articulation of the articulated arm constituting one of the elements of the device according to the invention;

FIG. 5 is a perspective view of a movable base constituting another one of the elements of the device according to the invention; and

FIG. 6 is a schematic cross-section view of a specific suitcase for including the device according to the invention.

### DETAILED DESCRIPTION OF THE INVENTION

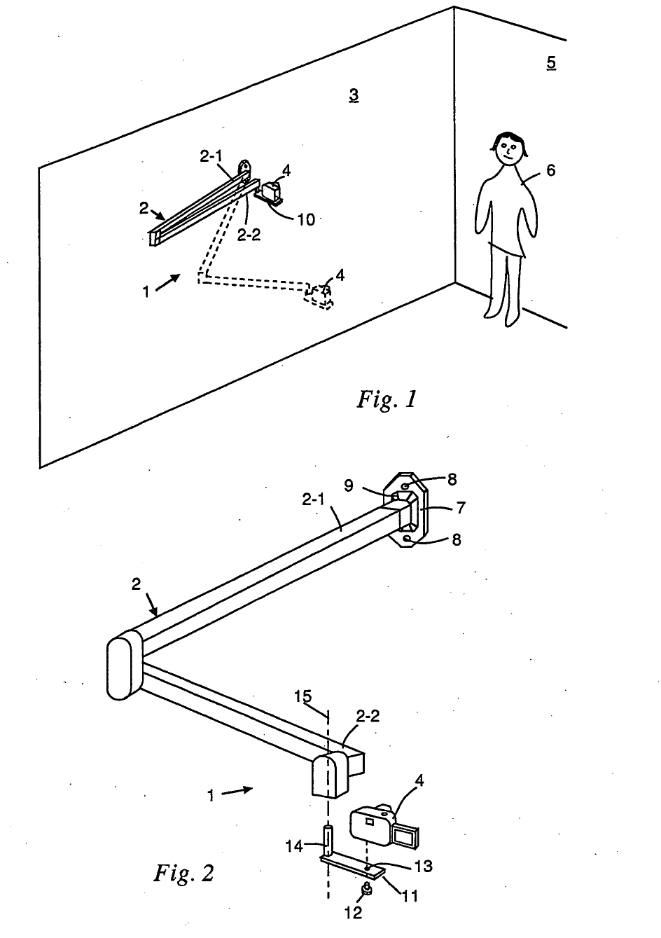

FIG. 1 shows the photograph taking device 1 set up in a context “ready to use”, the photograph taking waiting position being shown with a solid line and the photograph taking position being shown with a dotted line. This device 1 comprises an articulated arm means 2 comprising a first end 2-1 to be fixed to a stable vertical support 3 like a wall and a second free end 2-2, the second free end 2-2 being extensible into a photograph taking position and retractable into a photograph taking waiting position as respectively shown with a dotted line and a solid line. Furthermore, the device includes a photograph taking apparatus 4 fixed to the articulated arm means 2 at its second free end 2-2.

In operation, an operator catches in his hand the photograph taking apparatus 4 and extends the second free end 2-2 of the articulated arm means 2 while lowering it from the photograph taking waiting position (at about 2.50 m from the floor) to the photograph taking position (at about 1.50 m from the floor); at the same time, the operator orients the assembly “free end-photograph taking apparatus” along the left/right, downwardly/upwardly directions and in a circularly manner so as to bring the photograph taking apparatus 4 in the adequate photograph taking position to take a picture of the subject 6 who is isolated from the rest of the salon by a movable partition 5. As soon as the photograph taking is completed, the operator releases the photograph taking apparatus 4 and thus the free end 2-2 that, because of the springs system (not shown) incorporated in a native manner in the articulated arm means, returns in a springing and instantaneous manner to the photograph taking waiting position as shown with a solid line. The movable partition can then be moved for being tidied up. The photograph taking device 1 is then ready for a new photograph taking.

FIG. 2 is a detailed perspective view of the photograph taking device 1 in its photograph taking waiting position, the view showing its different constitutive elements. One can recognize the articulated arm means, composed of a first end 2-1 and of a second free end 2-2.

The first end is to be fixed to a stable vertical support like a wall (not shown) by means of a wall partition 7 and screws 8. A base 9 forms a native junction part between the wall partition 7 and the first end 2-1 of the articulated arm means. It is inside of this base 9 that, should this happen (in the case of a photograph taking apparatus supplied by electric current), a main alternative voltage-low voltage direct current transformer (not shown) would be housed, the electrical wire (not shown) to be connected to the photograph taking apparatus 4 and running inside the articulated arm means 2, the same as in the case of a classical joining to a hairdressing salon helmet.

The second free end 2-2, from which the hairdressing salon helmet has been removed, is mounted with the photograph taking apparatus 4 which replaces the original helmet. The mounting of the photograph taking apparatus 4 on the second free end 2-2 is effected by means of a mounting means 10 comprising a support stage 11 comprising, mounted on it, the photograph taking apparatus 4 and a freely rotatable linkage 14 permanently fixed, in a rigid manner and vertically to the articulated arm means 2, in a more precise manner on the second free end 2-2 where a recess (not shown) is provided in a native way for receiving the free rotatable linkage 14. The support stage 11 further comprises a fixing means 12, 13 for fixing the photograph taking apparatus 4 to the support stage 11. According to the shown embodiment, the fixing means 12, 13 is constituted by a threaded nut 12 that is screwed in a threaded hole 13 provided in the support stage 11.

It is to be noted that it is the rigid and stable mechanical structure of the photograph taking device 1, and in a more precise way, the stable fixing on a vertical wall of the first end 2-1 of the articulated arm means 2, as provided by means of the wall partition 7 and of the screws 8, and the permanent fixing, in a rigid manner and vertically of the free rotatable linkage 14 on the second free end 2-2 of the articulated arm means 2, that provide the horizontal maintenance of the support stage 11 regardless of the position of the articulated arm means 2, whereby the automatic horizontality of the centring when taking a photograph is provided, as above-mentioned.

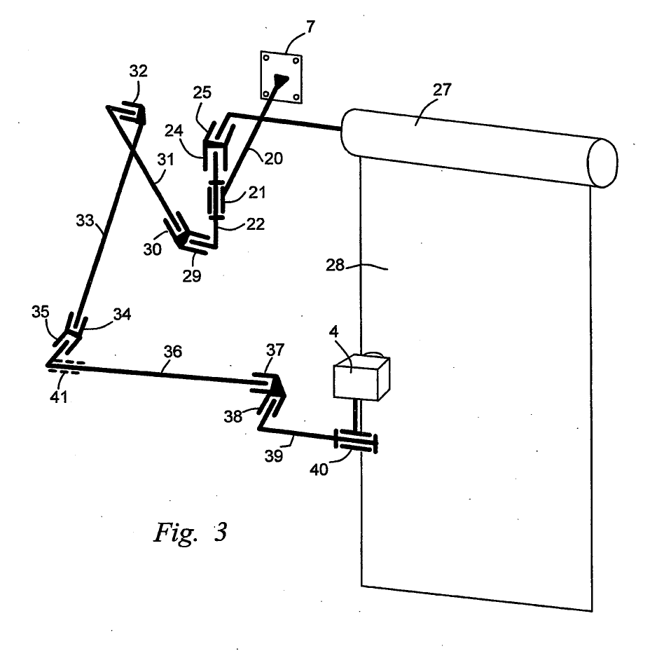

FIG. 3 is a schematic perspective view of the photograph taking device specifically showing the types of the cinematic linkages of the articulated arm. In this Fig., the wall partition 7 is fixed to a fixed element of the premises (not shown), for example a wall. From the wall partition, a fixed rod 20 provided with an articulation 21 at its free end that articulates with a vertical rod 22 extending both under and above where the articulation 21 horizontally extends. This articulation 21 is of the type for rotation about the vertical axis 23 and immobilization along the vertical axis 23. On the upper end of the rod 22 is fixed an articulation 24 of a vertical rotation axis the rotating part of which is fixed to an articulation 25 of a horizontal rotation axis the rotating part of which is fixed to a horizontal rod 26. The horizontal rod 26 supports at its free end a screen housing 27 from which a retractable screen 28 extends vertically downwards. On the lower end of the rod 22 is fixed an articulation 29 of a horizontal rotation axis the rotating part of which is fixed to an articulation 30 of a tilted rotation axis the rotating part of which is fixed to a tilted rod 31 (corresponding to the articulated arm part 2-1 of FIG. 2).

On the upper end of the rod 31 is fixed an articulation 32 of a horizontal rotation axis the rotating part of which is fixed to a tilted rod 33 (corresponding to the articulated arm part 2-2 of FIG. 2). On the lower end of the rod 33 is fixed an articulation 34 of a rotation axis along the longitudinal axis of the rod 33 the rotating part of which is fixed to an articulation 35 of a horizontal rotation axis the rotating part of which is fixed to a horizontal rod 36.

On the distal end of the rod 36 is fixed an articulation 37 of a horizontal rotation axis the rotating part of which is fixed to an articulation 38 of a horizontal rotation axis the rotating part of which is fixed to a horizontal rod 39. On the distal end of the rod 39 is fixed an articulation 40 of a horizontal rotation axis the rotating part of which is fixed to a support stage 41 (corresponding to the support stage 11 of FIG. 2) comprising, mounted on it, the photograph taking apparatus 4.

All the articulations, i.e. 21, 24, 25, 29, 30, 32, 34, 35, 37, 38 and 40 are articulations provided with a locking means by screw or handle. Optionally, anyone of these articulations can be permanently immobilized by a screw or any other fixing means not provided, for being operated by the user. Optionally, every articulation can be mounted with a static dry friction brake, the friction immobilization force of which is sufficient so that the position of the articulated arm stays fixed under the effects of the weights of the components but the friction force of which is not to high so that the user can alter the setting positions of the different articulated elements of the articulated arm.

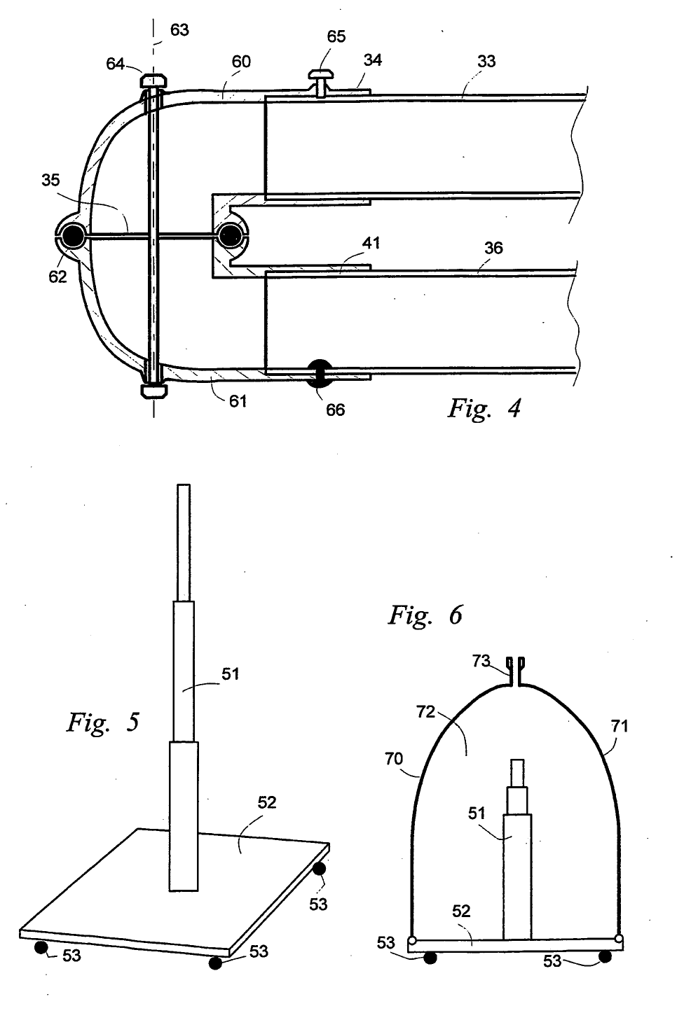

The articulation 25 is useful for passing the screen housing 27 on the other side of the articulated arm, as shown in FIG. 4. Thus, the screen housing 27 is always horizontal but reversed so that the face of the screen 28 serving as a background for the subject to be photographed is then the reverse face relative to the face of the screen 28 serving as a background for the subject to be photographed when the device is configured as shown in FIG. 3. In the same way, the articulation 35 is useful for passing the rod 36 and consequently the photographic apparatus 4 on the other side of the articulated arm, as shown in FIG. 4. In this case, it is also possible to add an articulation 41 of a rotation axis along the longitudinal axis of the rod 36 (shown with a dotted line in FIG. 3) for also allowing this passing on the other side of the articulated arm.

The articulation 38 is useful for passing the photographic apparatus 4 from the horizontal position (as shown in FIG. 3) for taking a photograph in landscape mode to a vertical position (not shown) for taking a photograph in portrait mode.

FIG. 4 is a more detailed cross-section view of an articulation of the articulated arm constituting one of the elements of the device according to the invention. On this Fig., one can distinguish in detail an articulation between any two of the rods (for example 22, 31, 33, 36 or 39) constituting the articulated arm according to the invention. According to the example of FIG. 4, it is an articulation between the rods 33 and 36. More exactly, this articulation constitutes the assembly of the three articulations 34, 35 and 41 between the rods 33 and 36, as described beforehand in connection with FIG. 3.

The articulation 34, which is an articulation rotating about an axis longitudinal to the rod 33, is obtained by means of the tubular rod 33 fitting in a corresponding bore of a housing 60. A locking screw 65 allows the immobilizing of this articulation. In a similar manner, the articulation 41, which is an articulation rotating about an axis longitudinal to the rod 36, is obtained by means of the tubular rod 36 fitting in a corresponding bore of a housing 61. A locking means 66 allows the immobilizing of this articulation. In the Fig., one can see the locking means 66 is in fact a rivet, i.e. in the shown example, the articulation 41 is blocked up because the locking means 66 is not unlockable. The articulation 35, which is an articulation about an axis perpendicular to the rods 33 and 36, is obtained by a relative pivot between the housings 60 and 61. An O-ring 62 (made of Rislan, trademark) permits a soft sliding, without squealing and jerking, between the two housings. A passing through bolt 64 permitting the constitution of a locking screw for immobilizing the articulation and also to mount and dismount the system. The housings 60 and 61 are hollow and as the tubular rods 33 and 36 are hollow, the assembly constitutes a continuous internal free way permitting a potential running of wires or other devices inside.

Preferentially, the articulations use a joint of the Rislan (trademark) type constituting an auto-lubricating contact avoiding the well known phenomenon of setting position squealing. Preferably, every articulation, in particular every horizontal articulation, can include a spring permitting the constitution of a permanent rotational force against a rotation due to the weight of the part supported by this articulation. Such a weight compensation internal spring is a well known mechanism per se for which a more detailed description is not necessary here.

According to an alternative, the wall partition 7 can be fixed on a vertical bracket (FIG. 5) comprising a vertical rod 51 fixed to a base 52 eventually provided with wheels 53, for constituting the whole device according to the invention in a freely movable way on the floor of the premises.

By reference to FIG. 6, according to another alternative, the device according to the invention is dismountable and can be accommodated in a suitcase specially designed to this end. This suitcase is constituted by a bottom that can be directly constituted by the base 52 (FIG. 5) above described and by two plastics articulated or hinged half-shells 72, 72. Thus, the device becomes easily transportable.

Preferentially, every rod is a rigid tube the diameter of which is 5 cm, made of plastics, a ferrous metal or preferentially, in aluminium or an aluminium alloy, eventually painted or anodized.

One can contemplate adding a bracket fixable to the ceiling for connecting in a fixed manner the partition 7 of the device to the ceiling of the premises, in the case where the user does not want or cannot set up the device against a wall of the premises.

According to an alternative, the printing machine can be fixed on the wall partition 7 or the bracket 51. Moreover, a further lighting or flash means can be mounted in a fixed or removable manner on one of the elements of the articulated or hinged arm, for example the rod 31 or 33.

The device according to the invention constitutes an “integrated photo studio”, i.e. including all the elements permitting a photograph taking in good conditions, that means a photograph apparatus mounted on an articulated or hinged arm, a background screen, a printing machine and eventually, a further lighting or flash means.

The device according to the invention that constitutes thus an integrated photo studio can be particularly used for hairdressing salons, opticians, accessories shops for wedding ceremonies, luxury stores, clothing stores, jewelleries, a cosmetic surgery office, retirement homes, tobacco stores, etc.

Although a particular embodiment of the present invention has been described, it must be well understood that the present invention can be carried out according to other variants of realisation and alternatives. For example, the fixing means 12, 13 could be constituted by elements other than the shown threaded nut 12 and threaded hole 13 assembly. All the technical equivalents falling in the frame of the appended claims are contemplated to be protected by the present patent request.

Different Arrangements

The photograph taking device (1) according to the invention can further comprise a memory means for saving in memory, under a filing form, said beforehand taken photographs.

The photograph taking device (1) according to the invention can further comprise a wireless connection, in particular an aerial connection or an infrared connection, to establish a communication link between said photograph taking apparatus (4) and said printing machine and/or said memory means.

The photograph taking device (1) according to the invention can further comprise an articulation or hinge means permitting a switching of the assembly constituted by said articulated or hinged arm and said photograph taking apparatus to the other side relative to said support stage (11), whereby the user can thus maneuver the articulated or hinged arm so that he can take a photograph with said photograph taking apparatus (4) located on the left or right side of the articulated or hinged arm, as desired.

The photograph taking device (1) according to the invention can further comprise an articulation means permitting a switching of said screen to the other side relative to said support stage (11), whereby the user can thus maneuver the screen so that he can take a photograph with said photograph taking apparatus (4) located on the left or right side of the articulated arm, as desired.

Moreover, the screen can have two opposed faces having different visual aspects, whereby the user can manoeuvre the screen to reverse it so that the background of the photograph is visually different according to the selected face of the screen.

The photograph taking device (1) according to the invention can further comprise a lighting or flash means (not shown) mounted in a fixed manner on said articulated arm.

Although the present invention has essentially made reference to a hairdressing/grooming salon, it is well agreed that such a photograph taking device could be easily implemented in a location other than a hairdressing/grooming salon (thalassotherapy and/or fitness centres, a hall of first-class hotels, as an addition to luxury stores, a waiting hall of an airport, . . . ).

1. A photograph taking device (1), comprising:
a photograph taking apparatus (4); and
an articulated arm means (2) comprising a first end (2-1) to be fixed to a stable support (3) and a second free end (2-2);
wherein:
said photograph taking apparatus is fixed to said articulated arm means (2) at said second end (2-2) of said articulated arm;
said second end (2-2) of said articulated arm means being extensible in a photograph taking position and retractable in a photograph taking waiting position;
a mounting means (10) provided for mounting said photograph taking apparatus (4) on said articulated arm means (2);
and further comprising:
a background screen (27, 28) fixed to said articulated arm means (2); and
a memory means for saving in memory, in a filing form, the beforehand taken photographs.

2. The photograph taking device (1) as claimed in claim 1, wherein said first end (2-1) can be fixed to a stable vertical partition (3) like a wall.

3. The photograph taking device (1) as claimed in claim 1, wherein said mounting means (10) comprises a support stage (11) comprising, mounted on said support stage (11), said photograph taking apparatus (4) and a freely rotatable linkage (14) permanently fixed to said articulated arm means (2).

4. The photograph taking device (1) as claimed in claim 3, wherein said support stage (11) further comprises a fixing means (12, 13) for fixing said photograph taking apparatus (4) to said support stage (11).

5. The photograph taking device (1) as claimed in any one of the preceding claims, further comprising a printing machine for printing photographs taken by said photograph taking apparatus (4).

6. The photograph taking device (1) as claimed in one of claims 5 or 6, further comprising a wireless connection, in particular an aerial connection or an infrared connection, to establish a communication link between said photograph taking apparatus (4) and said printing machine and/or said memory means.

7. The photograph taking device (1) as claimed in any one of the preceding claims, further comprising an articulation means permitting a switching of the assembly constituted by said articulated arm and said photograph taking apparatus to an other side relative to said support stage (11), whereby the user can thus selectively maneuver the articulated arm to take a photograph with said photograph taking apparatus (4) located on the left or right side of the articulated arm.

8. The photograph taking device (1) as claimed in any one of the preceding claims, further comprising an articulation means permitting a switching of said screen to an other side relative to said support stage (11), whereby the user can thus selectively maneuver the screen to take a photograph with said photograph taking apparatus (4) located on the left or right side of the articulated arm.

9. The photograph taking device (1) as claimed in claim 8, wherein the screen has two opposed faces having different visual aspects, whereby the user can maneuver the screen to reverse it so that a background of the photograph is visually different according to the selected face of the screen.

10. The photograph taking device (1) as claimed in any one of the preceding claims, further comprising a lighting or flash means mounted in a fixed manner on said articulated arm.
